(19) United States
(12) Patent Application Publication
(10) Pub. No.: US 2026/0160032 A1
(43) Pub. Date: Jun. 11, 2026

(54) HIGH PERFORMANCE ROAD MARKING DEVICE, SYSTEM, AND MANUFACTURING METHODS

(71) Applicant: 1 Visibility Technology LLC, Libertyville, IL (US)

(72) Inventors: Robert M. Pricone, Libertyville, IL (US); Harry E. Lowe, Schaumburg, IL (US); Dennis Couzin, Berlin (DE)

(21) Appl. No.: 19/411,737

(22) Filed: Dec. 8, 2025

Related U.S. Application Data
(60) Provisional application No. 63/729,632, filed on Dec. 9, 2024.
(60) Provisional application No. 63/817,384, filed on Jun. 4, 2025.

(51) Int. Cl. E01F 9/524; B23K 26/21; E01F 9/553; G02B 5/12

(52) U.S. Cl. CPC E01F 9/524; B23K 26/21; E01F 9/553; G02B 5/12

(57) ABSTRACT

Reflective devices with enhanced long-term reflectivity and reflectivity under water are provided. In embodiments, a reflective device includes a retroreflective strip on a front-upward angled surface. The reflective device comprises a lip that at least partially overhangs the front-upward angled surface and the retroreflective strip protecting it from damage. In embodiments, the reflective device is manufactured with geometrical retroreflective elements being embossed in an acrylate layer and a polyurethane protective top layer. Embodiments also include a system with reflective devices angled away from being perpendicular from the road and a method of joining the retroreflective strip to the pavement marking form.

### CROSS-REFERENCE TO RELATED APPLICATIONS

This application claims priority to U.S. provisional application 63/729,632, filed Dec. 9, 2024. This application also claims priority to U.S. provisional application 63/817,384, filed Jun. 4, 2025. These prior applications are incorporated herein by reference in their entirety.

### BACKGROUND

Advances in the road building and road/pavement marking industry are few and far between. The industry is slow to change, particularly because of the government regulation involved and the durability testing needed for an approved product. However, with the increasing average age of the population in general and of drivers in particular, as well as the implementation of self-driving vehicles that rely on optical indicators, there is an increasing need for improvements in reflectivity and sustained reflectivity in signs and devices used for pavement marking and signage.

Retroreflective pavement markings, which may also be referred to as road markers, are illuminated by vehicle headlights at night, reflecting light back to the driver's eyes (or optical receptors for cameras on self-driving vehicles) to clearly define traffic lanes and illuminate signage. These are typically in the form of stripes that are usually applied along the lateral edges of roadways, between lanes, and across intersections and crosswalks. The most common materials used are glass bead-filled paints or extruded polymers. The spherical beads embedded in the surface capture light and retroreflect it back toward the headlights, with some divergence to make it visible to drivers. However, conventional glass and ceramic bead products have limited reflectivity and visibility, especially in wet or low-light conditions, and their effectiveness diminishes over time as they deteriorate.

An alternative to traditional pavement markings are raised reflective pavement markers, often made from polymeric materials and using cube corner prisms for retroreflection. These markers can be more reflective than paint or tape but are more prone to wear and tear due to their protruding design. In addition, such markers may not be suitable with traditional reflective sheeting due to angle of reflection issues. Some raised reflective pavement markers are made with a special type of reflective sheeting that has reflectivity at a high incident angle to correspond with the high angle face of the pavement marker. In addition, raised reflective pavement markers are only single point reflectors as opposed to pavement markings, which are seen as a continuous line.

### SUMMARY

The following is a brief summary of subject matter that is described in greater detail herein. This summary is not intended to be limiting as to the scope of the claims.

In some aspects, the techniques described herein relate to a retroreflective pavement marking device including: a top surface and a bottom; a front-upward angled surface; a reflective strip attached to the front-upward angled surface; and a lip that at least partially overhangs the front-upward angled surface and the reflective strip.

In some aspects, the techniques described herein relate to a system for pavement marking on a road surface, the road surface having a center axis running along its longest dimension, the system including: first and second reflective devices each having a long axis running through the center of their longest dimension; the first and second reflective devices attached to a road surface, berm, or a groove in the road surface or berm; the first reflective device being spaced away from the second reflective device further up or down the road surface, berm, or a groove in the road surface or berm; at least the first reflective device being angled away from a 90 degree angle with the center axis of the road surface.

In some aspects, the techniques described herein relate to a method of making pavement markings, including: manufacturing a pavement marking form including a front surface for a reflective strip; positioning the reflective strip over the front surface; and laser welding the reflective strip to the front surface.

In some aspects, the techniques described herein relate to a method of making a retroreflective strip, including the steps of: combining a top layer over a bottom layer; the top layer including polyurethane and the bottom layer including an acrylate; embossing the bottom layer in a mold with retroreflective geometrical elements; releasing the molded and embossed top and bottom layer with the retroreflective geometrical elements intact; applying the top and bottom layer to a backing layer.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 depicts a perspective view of an embodiment of the reflective device.

FIG. 2 is a side-view of the reflective device illustrating various angles of the reflective device.

FIG. 3 is a side view of an embodiment of a reflective device installed on an adhesive coating on a road surface.

FIG. 4 is a cross-sectional view of an embodiment of a molded multilayered structure for the retroreflective strip.

FIG. 5 is a cross-sectional view of an embodiment of a multilayer retroreflective structure that incorporates the molded multilayered structure.

FIG. 6 is a cross-sectional view of another embodiment of a multilayer retroreflective structure with an optional additional adhesive layer.

FIG. 7 is an overhead schematic view of an embodiment of a road surface with a groove including an embodiment of an angled reflective device.

FIG. 8 is an overhead view illustrating an angled reflective device.

FIG. 9 is an overhead view of an alternative embodiment of an angled reflective device.

FIG. 10 is a flow chart illustrating an embodiment of a method for making a pavement marking.

FIG. 11 is a diagram of an embodiment of a laser welded reflective device.

FIG. 12 is a schematic illustrating a embossing system for making a retroreflective film.

FIG. 13 is a schematic of a specialized retroreflective film.

FIG. 14 is a chart showing various physical properties that were tested for an embodiment of the reflective devices along with the ASTM standards used.

FIG. 15 is photograph showing the format of the test samples that were tested in the Examples.

FIG. 16 is a table showing calibration data and the test results of two examples of the reflective device from opposite directions done by a certified testing laboratory.

### DETAILED DESCRIPTION

Various technologies pertaining to pavement marking devices and systems are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

Conventional pavement marking technology for stripe marking (typically single or double white or yellow lines) is based on reflective glass-bead or ceramic-beads to make them visible at night when viewed by a driver's headlights. Glass-bead or ceramic-bead technology has limited reflectivity, reduced visibility under wet night conditions and wears quickly over time. The night visibility and wet-night visibility is measured in millicandelas per square foot per footcandle (mcd/sf/fc) or in the metric equivalent of millicandelas per square meter per lux (mcd/m²/lx). The light is emitted by a light-projector source in a particular direction, in this case, the angle visible to the driver (See Table 1). A millicandela is a unit of measurement of the amount of light a light source emits in a particular direction. A typical example of glass-bead or ceramic-bead technology is 3M 380 Reflective Tape which has properties in mcd, as shown in Table 1.

TABLE 1

| | White | | Yellow | |
|---|---|---|---|---|
| | | Wet & Rainy | | Wet & Rainy |
| | Dry | ASTM E2832- | Dry | ASTM E2832- |
| Color | ASTM | 12 Or ASTM | ASTM | 12 Or ASTM |
| Condition/Test | E1710 | E2177 | E1710 | E2177 |
| Entrance Angle | 88.76° | 88.76° | 88.76° | 88.76° |
| Observation Angle | 1.05° | 1.05° | 1.05° | 1.05° |
| Coefficient of | 500 | 250 | 300 | 200 |
| Retroreflected | | | | |
| Luminance | | | | |
| [mcd/m²/lux] | | | | |

Guidelines promulgated by government agencies point to the need to continually maintain retroreflectivity of longitudinal pavement markings at or above the MUTCD specified minimum reflectivity levels (i.e., the required minimum of 50 mcd/m2/lux and the recommended minimum of 100 mcd/m²/lux for higher speed roads). The retroreflective devices disclosed herein are capable of reflectivity levels meeting or exceeding these requirements, e.g., 100 to 500 mcd/m²/lux, such as 200 to 400, or 250 to 350 mcd/m²/lux, or 9,000 to 12,000 mcd/m²/lux, such as 8,000 to 10,000, or 8,000 to 11,000 mcd/m²/lux.

Raised reflective pavement markers are another means to communicate with the driver at night. Raised retroreflective pavement markers are individual reflective devices, commonly used to supplement white or yellow lines. Since raised reflective pavement markers are generally employed above-grade, they are only widely used in warm locations because southern states generally do not use snowplows that would impact and remove or damage raised reflective pavement markers. In cold locations that that plow, if pavement markings are used they may be recessed or protected so they are not removed when plowed.

In an embodiment, the system disclosed herein may be in the form of a series of devices, the series running laterally to the length of road lane, i.e., at the edge or edges of the lane. The system includes first, second, and nth reflective devices spaced apart in distances running parallel with the length of the road lane. (The length of the road lane being its longest dimension including a direction in which traffic flows.) In contrast to paint or glass bead-filled compositions, the system and devices disclosed herein returns more light to oncoming vehicles and drivers. The product disclosed herein is designed to provide greater visibility over longer time periods compared to current products. Current products have significantly lower visibility and/or the which deteriorate quickly.

In locations where the roads are routinely plowed, the white or yellow paint lines are often recessed in a groove to protect them from plowing. Typically, the groove is 0.18″ to 0.20″ deep. The systems and devices disclosed herein are, in an embodiment, 0.12″ tall or less, minimizing tire impact. In locations that do not plow snow, embodiments of the devices used herein can be used without a groove.

In an embodiment, the devices and system disclosed herein incorporate micro-corner-cube technology in a system that is configured to be placed on a road surface or in a groove of the road surface and protected from snowplows. In an embodiment, the micro-corner-cube feature of the devices disclosed herein are in a thin film, generally 0.010″ thick or less. applied to a short profile device. Micro-corner-cube technology is orders of magnitude brighter than glass bead technology. The films and devices disclosed herein have reflectivity of 500-1,000 candela, e.g., 600 to 800 candela, or 650 to 750 candela, whereas glass beads in standard paint/bead products are orders of magnitude less, they are typically measured in Mcd (1,000× less). Millicandela (mcd) is a metric prefix modification of the candela (cd). One candela is equal to 1,000 millicandelas. Precision retroreflective optical patterns can be formed in various substrates. These, retroreflective structures may be microcubes, or prisms, and can be formed in a thin film resinous sheet or laminate. Further information on this is in U.S. Pat. Nos. 4,486,363; 4,478,769; 4,601,861; 5,213,872; 6,015,214, and 6,908,295, which are incorporated herein by reference. Highly precise embossing or other manufacturing methods at very small sizes is needed to make quality retroreflective materials because the geometric accuracy of the optical prismatic elements determines the film's optical performance. The patents referenced above provide some particular methodologies for embossing a repeating retro-reflective microprismatic pattern of precise optical detail on certain films.

In certain embodiments, a different type of reflector can be used for the retroreflective film. For example, the retroreflective material disclosed in U.S. Pat. No. 4,895,428 (incorporated herein by reference) with cube-comer prisms can be used, or even conventional non-retroreflective reflectors such as glass bead film, known as engineer grade, and high-intensity films that have been used for decades, since various types of reflective material can benefit from other features disclosed herein.

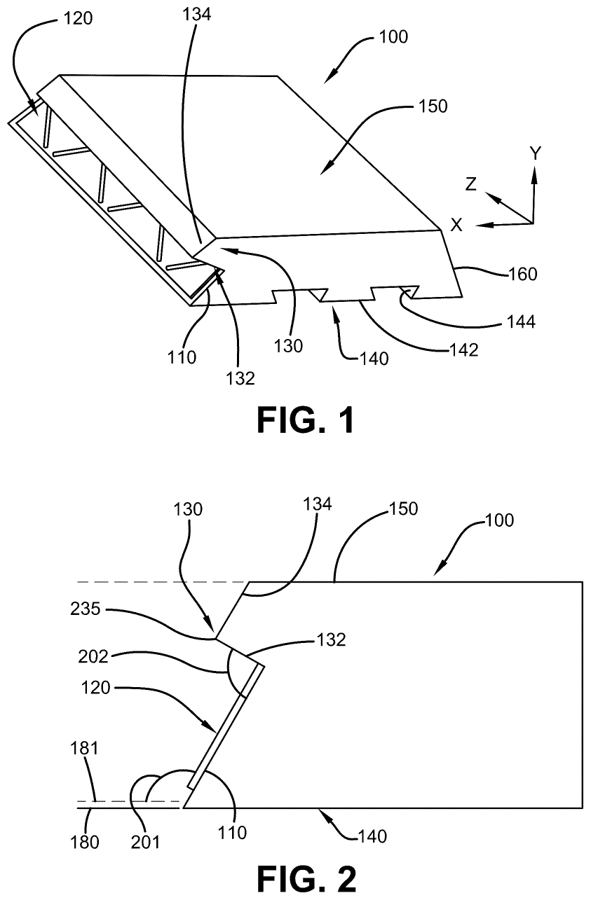

FIG. 1 depicts a perspective view of an embodiment of the reflective device 100. The reflective device 100 has a front-upward angled surface 110, on which, a retroreflective strip 120 is attached. The retroreflective strip 120 runs the entire width (z-axis) of the reflective device 100. In embodiment, the retroreflective strip 120 runs 50% to 99%, or 75% to 95% of the width of the retroreflective strip 120. Herein, a reflective device 100 without the retroreflective strip 120 is referred to as a pavement marking form. In an embodiment, the retroreflective strip 120 is 0.08 to 2 inches high (z-axis), such as, e.g., 0.1 to 1.2 inches, or 0.2 to 0.8 inches.

In an embodiment, the reflective device 100 is 0.12 inches high (z-axis), 4 inches wide (x-axis) and 1 inch long (y-axis). These dimensions may be varied to accommodate different road applications. For example, the length and width dimensions may be varied, for example, by a factor of 0.3 to 10, such as, for example, 0.5 to 4, or 0.8 to 1.5. The height may be varied, for example, by a factor of 0.7 to 20, such as 0.8 to 5, or 0.9 to 1.5. In an embodiment, the dimensions are desirably configured to be low-profile so as to avoid damage from snow plows, and to be sufficiently wide and tall enough to provide high reflectance at least on par with current glass bead technology or better. The length and width should also be sufficiently large to provide a solid base to durably adhere to a coating on the road surface.

Field testing of pavement marking devices over two years has determined that the area that incurs the most damage due to tire impact is at the top of the face. By providing a tire impact-absorbing lip or brow at the top of the device, it was determined that this can significantly reduce damage to the upper area of the reflective film and enhance the overall durability of the reflective device 100.

The reflective device 100 has a lip 130 that at least partially overhangs the front-upward angled surface 110 and retroreflective strip 120. In an embodiment, the lip 130 is an extension of the top surface 150. In an embodiment, when the reflective device 100 is viewed from the top (z-axis) the lip 130 may overhang, i.e., cover 50% to 100%, 75% to 99% or 80% to 95% of the front-upward angled surface 110 and/or retroreflective strip 120. In an embodiment, the lip 130 includes a bottom lip surface 132 and a top lip surface 134. The top and bottom lip surface 132 may be angled as shown in more detail in FIG. 2.

The bottom 140 of the reflective device 100 includes raised portions 142 with one or more undercuts 144. As shown, the raised portion 142 has a trapezoid-shaped cross-section. The raised portions 142 and undercuts 144 provide a better adhesion surface for adhesive coating that will hold the reflective device 100 to the road surface.

The reflective device 100 also comprises a top surface 150 and a back surface 160. In this embodiment, the top surface 150 is flat, and the back surface 160 can be vertical or sloped down and away in the x-axis dimension. The top surface 150 is configured to be contacted occasionally by automobile tires.

In an embodiment, for example, for use in a middle lane marker, the back surface 160 can be a duplicate of the front side, i.e., it may have a lip 130, front-upward angled surface 110, and retroreflective strip 120. This is so it can provide light reflection in both directions.

Pavement markings and lines are particularly difficult to see in the rain and/especially at night in the rain. Glass bead technology does not reflect well at all when they are covered with water. It was determined with the device disclosed herein that at a certain range of angles of the front-upward angled surface 110, surprising improvement over conventional technology was made in reflectivity underwater.

FIG. 2 is a side-view of the reflective device 100 illustrating various angles of the reflective device 100. The retroreflective strip 120 and/or the front-upward angled surface 110 are at a first angle 201 with respect to a horizontal plane 181 extending from the bottom 140 of the reflective device 100 or (when installed) with respect to the horizontal plane of the road surface 180. The first angle may be in a range of 110 to 145 degrees, such as 120 to 135 degrees, or 125 to 130 degrees. The first angle 201 is selected to reflect light back to an oncoming vehicle with sufficient time to see the reflective device 100 and adjust course to stay on the road or marked lane. The difference between the first angle 201 with respect to the front-upward angled surface 110 and retroreflective strip 120 will be minimal and only changed by the thickness of the retroreflective strip 120 by making the angle with the road surface 180 or horizontal plane 181 slightly more acute, e.g., 0.1 to 3 degrees.

The reflective device 100 has a lip 130 with a second angle 202 formed between the bottom lip surface 132 and the retroreflective strip 120 and/or front-upward angled surface 110. The second angle may be in a range of 50 to 130 degrees, such as 65 to 120 degrees, or 70 to 90 degrees. The difference between the second angle 202 with respect to the front-upward angled surface 110 and retroreflective strip 120 will be minimal and only changed by the thickness of the retroreflective strip 120 by making the angle with the bottom lip surface 132 slightly more acute, e.g., 0.1 to 3 degrees. The second angle 202 is selected so as not to block reflected light from reflecting back to an oncoming vehicle, e.g., at a distance of 30 meters, giving the driver or vehicle sufficient time to see the reflective device 100 and adjust course to stay on the road or marked lane. In an embodiment, the reflective device 100 disclosed herein is configured to reflect light at a distance of 30 meters to an eye, optical detector, or camera height 1.2 m and a headlight height of 0.65 m above the road.

In the embodiment, the top lip surface 134 meets the bottom lip surface 132 at a sharp edge 235; however, the edge can be rounded or flattened in other embodiments. The lip 130 has a third angle 203 formed between the top lip surface 134 and a plane extending from the top surface 150. The third angle 203 may be, for example, 1 to 90 degrees, e.g., 35 to 55 degrees, or 40 to 50 degrees. In an embodiment, the third angle 203 is 0 degrees, meaning that the top surface 150 is coplanar with the top lip surface 134.

The purpose of the lip 130 is to protect the retroreflective strip 120 from damage from tire strikes while still allowing light from oncoming vehicles, e.g., at 30 meters to reflect at a sufficient angle to be visible from the vehicle, e.g., at 30 meters.

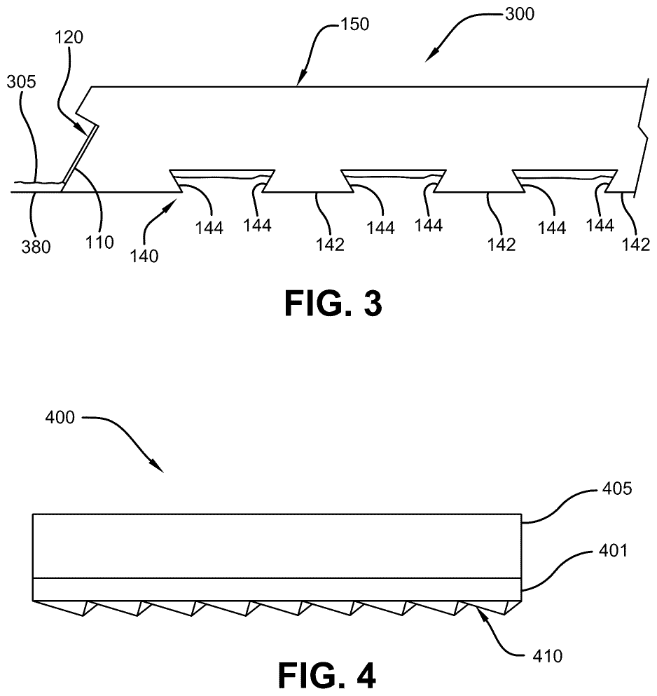

FIG. 3 is a side view of an embodiment of a reflective device 300 installed on an adhesive coating 305 on a road surface 380. The adhesive coating may be a durable paint striping material, such as a polyacrylate-, epoxy- or polyurea-based composition. In an embodiment, the adhesive coating is 3180 MFUA-10 White from SWARCO Colorado Paint Company. The adhesive stripe can also be colored with pigment, e.g., white or yellow. The adhesive coating 305 functions to hold the reflective device 300 in place during curing. After application of the colored adhesive in a stripe on the road lane marking, the reflective device 300 can be placed into the still soft coating. After curing the reflective device 300 will be durably bonded to the road surface 380. Alternatively, the reflective device 300 can be placed on the road surface 380 with an adhesive backing applied to the bottom 140 of the reflective device 300, for example, by dipping the reflective device 300 in the adhesive.

The reflective device 300 may have multiple raised portions 142 with one or more undercuts 144, which function to provide an enhanced mechanical gripping surface wherein the cured adhesive is a hardened physical barrier to removing the reflective device 300 from the road surface 380. There may be, for example 1 to 20 one or more raised portions 142 with one or more undercuts 144. In an embodiment, instead of raised portions 142 with one or more undercuts 144 running in a line, the one or more undercuts 144 may surround four sides of the raised portions 142 to provide even more surface area for the adhesive coating 305 to grip.

In one example, the reflective device 100 is attached to the road surface 380 which is coated with the polyacrylate, epoxy or polyurea adhesive. The adhesive will remain tacky for several minutes after application. The tacky surface allows the sections of reflective device 100 to adhere and permanently bond after the polyurea cures.

The cure time of the adhesive can be adjusted depending on the installation time required for the reflective device 100. The underlying colored adhesive stripe could be applied 1 to 12 inches, or 101 mm to 153 mm (4 inches to 6 inches) wide as typical lane markings. The reflective device 100 will retroreflect light to the drivers' eyes with higher intensity than glass bead or ceramic bead products and is better protected from tire abrasion by the flat top surface and lip 130 in the pavement.

The reflective devices 100 are visible from a distance, i.e. not completely blocked by the reflective device 100 in front of them on a flat surface. The ASTM E1710 test for the US is based on a 1.05 degree observation angle which corresponds to an observation distance of 30 m. At 30 m the space from reflective device to reflective device should be 46 times the marker height. Therefore, a reflective device height of 3.0 mm (0.20 inches) can be at a spacing of 138 mm (5.4 inches) to allow the reflective devices to appear as a continuous line.

The reflective devices 100 may be spaced apart, e.g., by 50 mm to 300 mm, such as 80 to 175 mm, or 100 to 150 mm. In an embodiment, the reflective devices 100 are spaced closely enough to prevent a standard sized, e.g. 17 inch tire from touching the bottom of the road surface. That is, the reflective devices 100 may be spaced to allow the tires to run along on the tops of the reflective devices 100.

In one example, the reflective devices 100, e.g., first and second reflective devices 101, 102 are attached to a road surface, berm of the road surface, or the bottom of a milled groove in the road surface or berm of the road surface that is used to protect from traffic wear and snowplows. In an embodiment, the first and second reflective devices 101, 102 are parallel to each other and area spaced In other embodiments the first and second reflective devices 101, 102 are placed on a road surface or on a plane with the main road surface, i.e., not in a groove.

In an embodiment, the reflective device 100 may have a coefficient of retroreflected luminance [mcd/m2/lux] of at least 1,000, such as 1,100 to 5,000, or 1,200 to 2,000, at an entrance angle of 88.76° and an observation angle of 1.05°. This 88.76° angle is measured between the incident light and the normal to a stripe, that is, the normal to the road.

In an embodiment, the first and second reflective devices 101, 102 and/or the retroreflective strip 120 on one of the first or second reflective devices 101, 102 can have different retroreflective geometrical elements that that achieve two or more angles of reflectance, e.g., a first and second angle of reflectance. A first reflective device 101 can have a retroreflective strip 120 with a first angle of reflectance and the second reflective device 103 can have a retroreflective strip 120 with a second angle of reflectance.

In an embodiment, the first and second angle of reflectance differ in their reflectance angle in the vertical dimension. These angles of reflectance can be varied by, e.g., plus or minus 30 degrees, such as, e.g. plus or minus 15 degrees or plus or minus 10 degrees.

By varying the angles of vertical reflectance, this promotes improved visibility for both low-seated vehicles such as cars and motorcycles as well as high-seated vehicles such as trucks, busses, and semis. In an embodiment, there are at least two different angles of divergence, e.g., one configured for cars at an eye height of 1.2 meters and one configured for semi-trucks at an eye height of 2.4 meters.

Alternatively, two or more differently configured reflective devices 100 could be used and alternated, e.g., one for cars and one for semi-trucks. That is, a first reflective device 101 has its front-upward angled surface 110 and retroreflective geometrical elements configured to reflect light to a first eye height, and a second reflective device 102 placed further down the road configured to reflect light to a second eye height. The next reflective device 100 placed further down the road corresponds to the first reflective device 101 in terms of being configured to reflect light to a first eye height.

Currently, pavement markings are typically measured at 1.05° observation angle, 88.76° entrance angle. Certain testing for pavement markings in the U.S. is based on a 1.24 degree observation angle. Testing for raised certain reflective signs per ASTM 4280 is based on a 0.2 degree observation angle. In other pavement marking embodiments, the divergence angle could be configured to reflect light at 1.05° observation angle plus or minus 0.2°. In an embodiment, the varied angles of divergence may be less than 1.054°, to target observation at further than 30 meters, such as 0.85° to 1.03°, or 0.90° to 1.04°.

As discussed previously, an engineering challenge with pavement markings is to produce long-lasting durable devices that remain on the road and do not degrade in reflectivity. Through research and testing, it was determined that a reflective device 100 situated at 90 degrees to the road surface took additional and unnecessary impact force from sand, rocks, and other particulates or sources of debris flying into them from passing vehicles. This caused the flying materials to impact the reflective device 100 at the harshest angle, blasting the face of retroreflective strip 120, and causing a degradation in reflectivity over time. Surprising improvement was found by tilting (horizontally angling) the reflective device 100, or, more particularly, the retroreflective strip 120 away from a 90 degree angle with the center axis 783 of the road surface 780.

In an embodiment, the reflective devices 100 can be set down and horizontally angled (i.e., angled within the plane of the road) and away from a 90 degree angle with the center axis 783 of the road surface 780.

FIG. 8 is an overhead schematic view of a road surface 780 with a groove 782 that runs parallel to the center axis 783 of the road surface 780. A series of reflective devices 100 are spaced out in sequence in the groove 782 (or in other embodiments, spaced out in sequence along the road surface 780 or berm) a first reflective device 101 being spaced further up the road surface, berm, or groove in the road surface or berm. In an embodiment, the groove 782 or grooves are intermittently spaced and interrupted with areas that are level with the road surface 780 or berm.

In other embodiments, the reflective devices can be in first and second grooves running parallel to the central axis 783 on either side of the road surface 780. The first groove corresponds to traffic running up the road surface 780 on the right-hand lane, and the second groove corresponds to traffic running down the road surface 780 on the left-hand lane, which is typical for US and other right-hand drive countries driving laws. Up or down the road surface, berm, or a groove in the road surface or berm means parallel to the direction of the center axis 783.

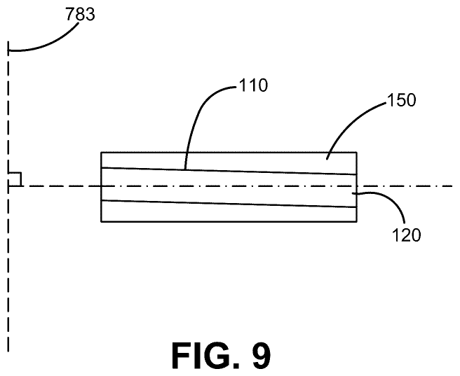

FIG. 9 is an overhead view further illustrating the angled reflective device 100. In this embodiment, the reflective devices 100 are angled with respect to the road surface and not parallel to the center axis 783 of the road surface 780. The reflective device 100 is placed in the first groove 782 and has a long axis 804 running through the center of the longest dimension of the reflective device 100. The road surface 780 has a center axis 783. A perpendicular line 808 running at 90 degrees from the center axis 783 intercepts the center 809 of the left edge 811 of the reflective device 100. A horizontal angle 803 is formed between the long axis 804 and the perpendicular line 808. This horizontal angle 803 is what is referred to as the angle of the reflective device 100 with respect to the road surface 780.

In an embodiment, the horizontal angle 803 of the reflective device 100 is 2 to 45 degrees, such as, e.g., 5 to 30 degrees, 15 to 25 degrees, or 10 to 20 degrees. In an embodiment, the reflective device 100 is angled to reflect light back to a spot that is 1.5 to 3 meters to the left of the left edge 811 of the reflective device 100 and 30 meters away. This should approximately center the reflected light to the driver in the horizontal plane of the road surface 780 at 30 meters away from the reflective device 100. More specifically, the reflective device 100 swiveled at a 20 degree angle will approximately center the reflected light to be seen by a pavement marking photometer at a 1.05° observation angle, 34.5° entrance angle, 37.2° orientation angle, and 10.3° rotation.

In certain embodiments, the retroreflective geometrical elements can be configured to adjust for the selected horizontal angle 803 and cause the reflected light to be centered parallel to the center axis 783 at 30 meters from the reflective device 100, or slightly, e.g., 2 to 6 degrees, further towards the center axis 783 of the road surface 780 than directly perpendicular to the center axis. Thus, even embodiments where the horizontal angle 803 is negatively angled (i.e., the long axis 804 is higher or further up the road from the perpendicular line 808 in FIG. 8) can be employed with retroreflective geometrical elements properly configured to reflect light back toward the center axis 783.

In an embodiment, as shown in FIG. 9, certain elements of the reflective device 100, e.g., the top surface 150, back surface 160, and/or lip 130 are placed on the perpendicular line 808 (which is at a 90 degree angle to the center axis 783), but the front-upward angled surface 110 and retroreflective strip 120 are horizontally angled within the reflective device 100 as described herein. In an embodiment, the lip 130, front-upward angled surface 110, and retroreflective strip 120 are horizontally angled away from 90 degrees with the center axis 783 as described herein. In this case, the retroreflective strip 120 may be recessed top surface 150 and/or back surface 160. The reflective device 100 may be located on the berm (left or right), or between lanes, and may be in a groove as disclosed above.

The reflective device 100 may be formed of a polymer that is strong, abrasion resistant and has high impact strength such as high-impact, abrasion resistant polyurethane or acrylonitrile-butadiene-styrene (ABS). Polyurethane resin can be cast onto a mold and cured. The polymer can be colored white, yellow or any other color that may be required. In an embodiment, the retroreflective strip 120 attached to the front-upward angled surface 110 can be of the same color as the front-upward angled surface 110.

In an embodiment, the surface of the reflective device 100 is constructed such that reflectivity of the retroreflective strip 120 is maintained at 75% or more, e.g., 80% or more, or 90% or more, for at least three years. Reflectivity can be degraded from various types of sources, such as, physical scratching, chemical etching, or delamination of the layers of the retroreflective strip 120.

Aliphatic thermoplastic urethane (TPU), such as what is used to protect paint on cars (paint protection film or wrap) is known to be self-healing. The EXPEL company provides such TPU products. Unfortunately, because of the adhesive properties of TPU at elevated temperatures, it cannot be embossed with the corner cube reflective properties utilized in the devices disclosed herein. The TPU will adhere to the mold and it was impossible to remove it without destroying the retroreflective corner-cube features.

The inventors determined that a solution to the problem of embossing retroreflective corner cubes in aliphatic TPU was to use a thin layer of polymethyl methacrylate (PMMA) film between the TPU film and the embossing mold. It was determined that this unexpectedly and successfully allowed the combined films to be embossed and released from the mold with intact retroreflective geometrical elements.

Prior retroreflective structures laminated the TPU onto the retroreflective layer. However, it was determined that the layer of PMMA could be applied to the TPU, then embossed (molded) and both layers could be cured in the mold together providing a very durable bonded multilayer structure. With the PMMA as the inside layer, the embossed film can be processed using downstream processes just as if the whole multilayer film was PMMA. The advantage of the multilayered retroreflective film is that the scratch resistant, self-healing TPU material is on the outside layer with the retroreflective corner-cube features embossed on a thin inner layer in the inside.

FIG. 4 is a cross-sectional view of a molded multilayered structure 400 for the retroreflective strip 120, which as a whole may be, e.g., 532 microns (0.021 inches) thick. In other embodiments, the molded multilayered structure 400 for the retroreflective strip 120 may have a thickness of 250 to 1000 microns, 350 to 750 microns, or 450 to 600 microns. An inner retroreflective layer 401 comprises or consists of acrylic, (e.g., PMMA) that includes the molded retroreflective geometrical elements 410, The top layer 405 is the polyurethane-based layer, (e.g., aliphatic thermoplastic urethane TPU). The top layer 405 may be 152 microns thick (0.006″). In other embodiments, the top layer 405 may have a thickness of 100 to 500 microns, 125 to 350 microns, or 130 to 175 microns. The inner retroreflective layer 401 may be 380 microns thick (0.015″). In other embodiments, the inner retroreflective layer 401 may have a thickness of 200 to 800 microns, 250 to 550 microns, or 350 to 425 microns.

The molded retroreflective geometrical elements 410 are prisms molded integrally into the retroreflective layer 401. The molded retroreflective geometrical elements 410 are sealed, e.g., with the PMMA walls blocking any water incursion into the air gaps 415.

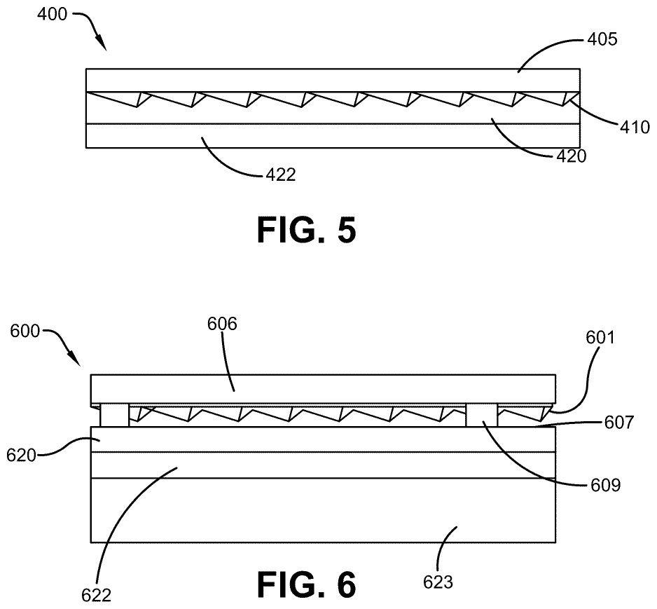

FIG. 5 is a cross-sectional view of a multilayer retroreflective structure 500 that incorporates the molded multilayered structure 400. A reflective backing layer 420, comprising or consisting of, for example, a metal, such as vapor-deposited aluminum, can then be applied to the inner retroreflective layer 401 which has molded retroreflective geometrical elements 410. An adhesive layer 422 can then be added to the bottom of the reflective backing layer 420. The adhesive layer 422 may comprise a pressure-sensitive adhesive and is used to attach the molded multilayered structure 400 to the reflective device 100, specifically at the front-upward angled surface 110.

In the embodiment of FIG. 5, the metalized reflective backing layer 420 allows retroreflectivity without an air gap as shown in other embodiments. This changes the distribution of light and the color is shifted slightly grey. A metalized product with slightly different light distribution may have an advantage in some embodiments. For example, this embodiment with the metallized reflective backing layer increases the reflectivity at high-incidence angles.

In operation, the light will pass through the top layer 405 and be reflected by the three faces of the molded retroreflective geometrical elements 410 in the retroreflective layer 401, which results in a reversal of direction as it exits back through the inner retroreflective layer 401 and top layer 405.

FIG. 6 is a cross-sectional view of another embodiment of a multilayer retroreflective structure 600 developed to manufacture traffic signs, which may also benefit from the features disclosed herein. For example, the laser welding technique can be used to weld layers such as the inner retroreflective layer 601 to the reflective backing layer 620 or to aluminum sheet 623. The multilayer retroreflective structure 600 includes a top transparent layer 606 (which may comprise transparent PMMA) with an inner retroreflective layer 601 comprising molded retroreflective geometrical elements 610 attached thereto. An air interface 607 is between a portion of the inner retroreflective layer 601 and the reflective backing layer 620, and the inner retroreflective layer 601 and reflective backing layer 620 are coupled by cell walls 609, which can be formed ultrasonically. The air interface 607 and the reflective backing layer 620 behind it allow the layers to be attached to an aluminum sheet 623 with a pressure-sensitive adhesive 622 to provide a traffic sign. The method to provide the air interface 607 on the bottom side of the inner retroreflective layer 601 is to ultrasonically bond the reflective backing layer 620 to the inner retroreflective layer 601 using a cell wall pattern for the cell walls 609. Ultrasonic bonding has been used to apply reflective films to substrates. However, durably attaching the multilayer retroreflective structure 500 to the front-upward angled surface 110 of the reflective device 100 is another engineering problem that the inventors faced. It was determined that it was not feasible to attach the multilayer retroreflective structure 500 to the reflective device 100 using ultrasonic bonding methods without a raised pattern on the surface of the ABS housing. Furthermore, a valuable and preferred manufacturing process of making the pavement marking form (reflective device 100 exclusive of the retroreflective strip 120) is profile extrusion. However, it was determined that profile extrusion methods are not capable of providing the raised pattern.

As an alternative, it was determined that laser welding provides a viable way of bonding the retroreflective strip 120 to the front-upward angled surface 110 of the reflective device 100. In particular, a 1650 nm (red pilot class 2 laser welder) was tested successfully for bonding the retroreflective strip 120 to the front-upward angled surface 110 of the reflective device 100. The laser can be used to weld the thin layer of acrylic PMMA to the front-upward angled surface 110. The laser welding can be done by moving the laser along the outside edges of the retroreflective strip 120 as it is set in place on the front-upward angled surface 110, either by moving the laser or the reflective device 100. Laser welding creates a very durable bond that contributes to enhanced durability of reflective performance over time compared to conventional means as it prevents delamination and ingress of water into the retroreflective strip 120.

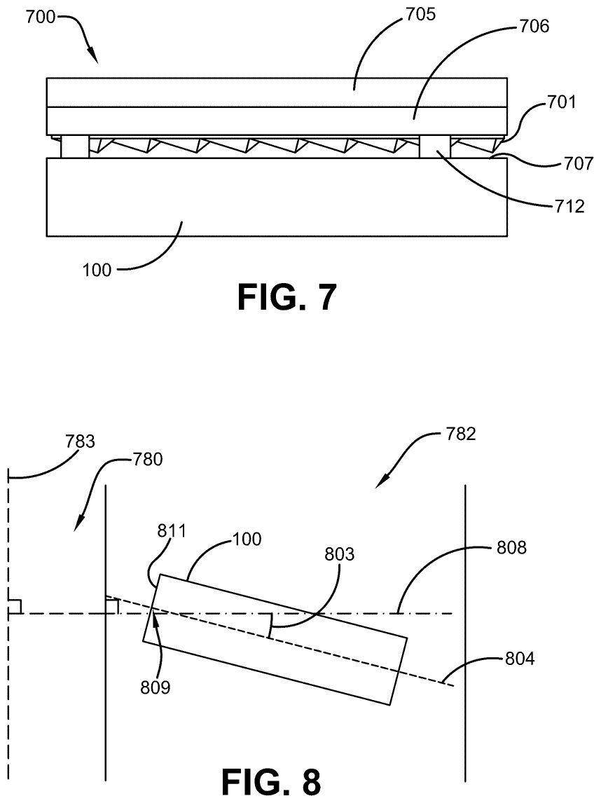

FIG. 7 is a cross-sectional view of another embodiment of a reflective device 700. The reflective device 700 includes a top layer 405 comprising polyurethane that overlays a top transparent layer 706. The reflective device 700 is laser welded to the reflective device 100 with an air interface 707 between the inner retroreflective layer 701 and the reflective device 100. The laser-welded lines form a sealed cell with walls 712 along all sides hermetically sealing the air between the reflective device 100 and the inner retroreflective layer 701. Submersion in water for several days demonstrates the cells are hermetically sealed and will not allow debris or water to enter the cells, which would cause the prism surface to be contaminated.

It is also possible to adhere the multilayer retroreflective structures in the figures above to the reflective device 100 without laser welding.

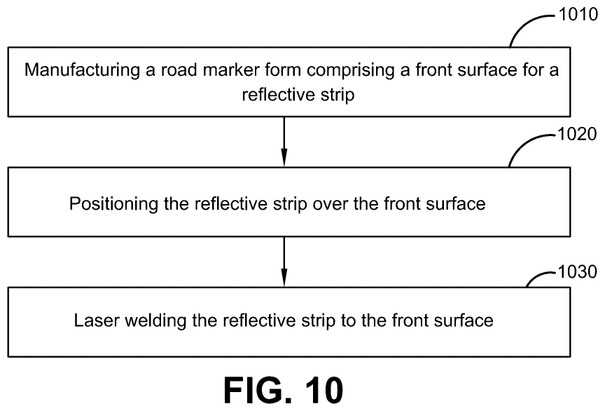

FIG. 10 illustrates an exemplary methodology relating to manufacturing pavement marking devices and systems of pavement marking. While the methodologies are shown and described as being a series of acts that are performed in a sequence, it is to be understood and appreciated that the methodologies are not limited by the order of the sequence. For example, it is contemplated that some acts can occur in a different order than what is described herein. In addition, it is contemplated that an act can occur concurrently with another act. Further, in some instances, not all acts may be required to implement a methodology described herein.

Referring now to FIG. 10, a methodology that facilitates manufacture of retroreflective pavement marking devices is illustrated. At step 1010, a pavement marking form is manufactured, which in this embodiment comprises profile extruding a plastic or metal to form an extruded profile. This can be done while it is pliable, i.e., above its glass transition temperature. Other methods of forming a pavement marking form can also be used, such as, for example, injection molding or thermoforming. The manufacture of the pavement marking form may be, for example, in any of the shapes and dimensions disclosed herein.

In an embodiment, extrudable plastic compositions, e.g., those comprising ABS or polyurethane as the majority materials for the pavement marking forms. Metals such as aluminum could alternatively be used.

At step 1010, the extruded profile is cut to manufacture the pavement marking form. A long or continuous strip of extruded material can be cut in multiple places, typically at regular distances to facilitate numerous iterative productions of the pavement marking form.

At step 1020, the reflective strip is positioned over a front surface of the pavement marking. This can be done manually or with a robotic device, such as a pick and place robotic device or with other manufacturing devices.

At step 1030, the reflective strip is laser welded to the front surface. This can be done by laser welding along a rectangle along four edges of the reflective strip. In other embodiments, a cell pattern can be laser welded in the reflective strip joining it to the front surface to provide multiple closed cells in a single reflective strip.

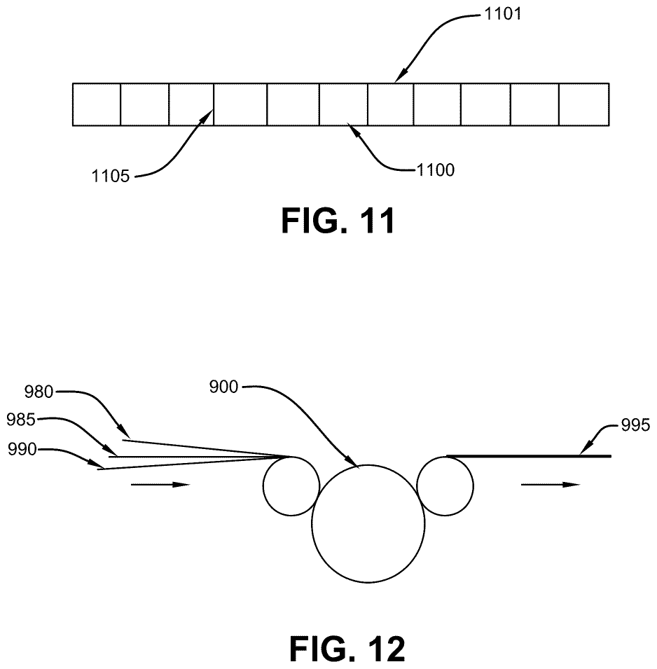

In another embodiment, the positioning step 1020 and laser welding step 1030 are conducted prior to the cutting of step 1010. In such an embodiment, the continuous extruded profile can be contacted with a continuous reflective strip such that a long strip of the reflective strip is placed on the front surface of the pavement marking form profile. In an embodiment, 1 to 50 feet at a time, can be laser welded in a continuous process aided by conveyers moving the pavement marking form front surface and reflective strip into position for laser welding. After laser welding occurs, then the pavement marking forms can be cut into individual forms at lengths disclosed above. FIG. 11 is a diagram showing a laser welded reflective strip 1100. The laser-welded lines form an outer sealed cell wall 1101 with four sides. Smaller discrete cell walls 1105 can be formed by the laser welding to separate the larger cell into sub-cells. Submersion in water for several days demonstrates the cells are hermetically sealed and will not allow debris or water to enter the cells that would cause the prism surface to be contaminated.

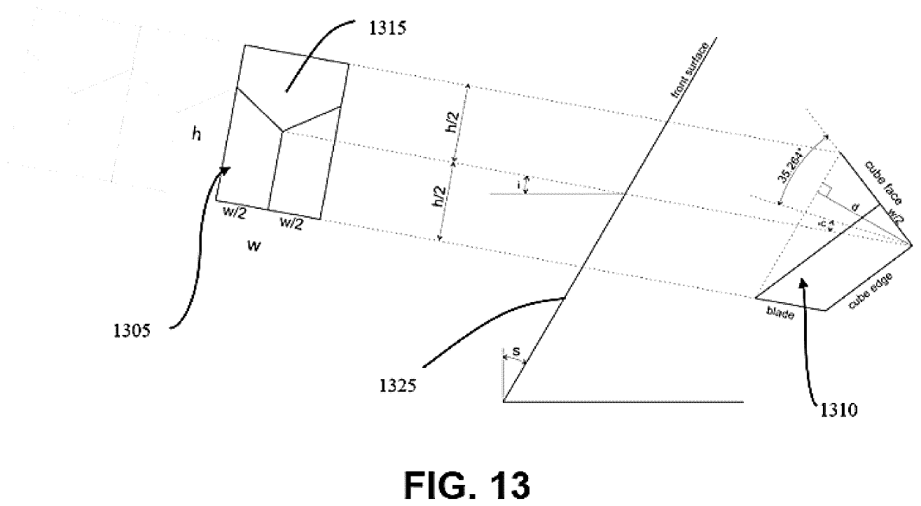

FIG. 12 is a schematic disclosing an embodiment of a hot mold embosser system 900 for manufacturing a retroreflective strip as disclosed herein. A TPU (thermoplastic polyurethane) layer 985, PMMA (polymethylmethacrylate) layer 980 and a carrier layer 990 are all fed into an embosser that is configured with geometrical elements to form the retroreflective prisms in the inner retroreflective layer 701 in the PMMA layer 980. An embossed multilayer film 995 exits the embosser system 900 with a prism structure on the bottom of the PMMA layer 980. By embossing the layers in this manner, the TPU 985 is now on the surface and forms a protective outer layer over the PMMA after the carrier layer 990 is removed.

In an embodiment, specialized retro-reflective sheeting is used to account for the front-upward angled surface 110 and the horizontal angle of the reflective device 100. This specialized retro-reflective sheeting is applied to the front-upward angled surface 110 as the retroreflective strip 120.

The specialized retro-reflective sheeting includes retroreflective geometrical elements that are configured to cause retroreflected light to be centered parallel to the center axis of the road surface at 30 meters from the reflective device, or 2 to 6 degrees, e.g., 2.5 to 5, or 3 to 4.5 degrees further towards the center axis of the road surface than directly perpendicular to the center axis.

FIG. 13 is a schematic of a corner cube prism 1310 for a specialized reflective device primarily showing (on the right) a side cross-section of the corner cube prism 1310. The projection 1305 to the left is an internal view of the cube corner viewed in the direction of the dashed lines connecting the internal view to the corner cube prism 1310 on the right. Those dashed lines make angle i (10.42°) with a horizontal line parallel to the road. The refraction making the angle i occurs at the sheeting front surface 1325. Angle i measures by how much an entering ray, parallel to the road, refracts at the front surface of the device. The angle s is 30° in this embodiment, and equates to a first angle of 120°. The center dotted line is the principal refracted ray. W/2 on the corner cube prism 1310 indicates that the w/2's on the projection 1305 are of the same length. A bevel face 1315 is cut to the midpoint of the plate; and grooves are ruled perpendicular to the direction of the cut of the bevel face 1315 to a depth equal to w/2 as shown in FIG. 13 where w in FIG. 13 is the dimension of the side of the rectangle perpendicular to h. In this embodiment, the cube corner prisms are behind a flat sheeting with a front surface 1325. In this embodiment, the sheeting is 1.5 times the cube depth (d) in thickness. In other embodiments, the sheeting may be 0.5 to 5 times, 1 to 3 times, or 1.25 to 2 times the thickness of the cube depth (d).

In an embodiment, the retroreflective elements are micro-cube corner prisms. is the main optical difference between macrocubes and microcubes. Diffraction is the spreading of a light beam caused by restriction of the beam size. Diffraction For the observation angles associated with applications such as highway markings (approximately 0.1 to 1.5), the diffraction effects for microcubes may be significant, while those for macrocubes are insignificant. For macrocubes observation angularity is completely determined by the dihedral angles, the flatness of the faces, and the cube shape, but for microcubes, size is an additional determinant.

Further angles shown in FIG. 13 are described as follows with designators known to those of skill in the art (e.g., as evidenced by U.S. Pat. No. 6,767,102, incorporated herein by reference). Observation Angle (α): The angle between the illumination axis (light source to retroreflector) and the observation axis (retroreflector to receiver). The α angle indicates how far from the center of the cone of retroreflection the measurement is taken and is usually less than 10° depending on the horizontal entrance angle. Entrance Angle Components (β1 and β2): The entrance angle (β) is the angle between the illumination axis and the retroreflector axis. It determines how light enters the retroreflector. β1 represents the “up and down” entrance angle, while β2 represents the “side to side” entrance angle. These angles can be positive or negative depending on the tilt of the retroreflector.

The entrance angle may be defined as the angle between the illumination axis and the optical axis (retroreflector axis). Note the distinction between entrance angle and angle of incidence. The angle of incidence is always measured between the incident ray and the normal to the surface (which may or may not be the retroreflector axis), whereas the entrance angle is measured between the incident ray and the retroreflector axis (which may or may not be the normal to the surface). Entrance angle is a measure only of the amount by which an incident ray is angled to the retroreflector axis, and is not concerned with the normal; angle of incidence is a measure only of the amount by which an incident ray is angled to the normal, and is not concerned with the retroreflector axis. For example, a pavement marker may be designed for the normal to the marker surface to be angled 60° to the optical axis; if light from an approaching vehicle is incident upon that marker along the retroreflector axis, the entrance angle is 0° and the angle of incidence is 60°, if light from an approaching vehicle is incident on the marker at a horizontal angle of 20° with respect to the retroreflector axis, the entrance angle is 20° and the angle of incidence is 61.98°=[cos−1(cos 60) (cos 20)].

Rotation Angle (ε): This angle is controlled by rotating the sample or the receiver around the light source. It ranges from 0° to 360° and dictates the rotation of the receiver relative to the retroreflector. β2 and ε are not shown on FIG. 13, since they extend into the plane of the 3^{rd} dimension (depth) that is not shown. The angle marked 35.26 is a “cutting angle”.

These specialized retro-reflective elements include efficient functioning geometries at entrance and orientation angles depending on the first angle 201 of the front-upward angled surface 110 (FIG. 2) on the reflective device 100 and the horizontal angle 803 of the reflective device 100 (See FIG. 8). For example, if the slopeback is 30° (or first angle of 120°, see FIG. 2), there should be efficient functioning at β=35.5° (entrance angle), ω=±36° (orientation angle). In an embodiment, the retroreflective device's slopeback is 30° (or first angle of 120°, see FIG. 2), there is ±20° horizontal entrance angle tolerance, and the optical requirement on the sheeting is at approximately β=35.5°, ω==36°. Such entrance angularity is not specified for sign sheetings, and thus these specialized retroreflective films are different from conventional sheeting.

Also the retroreflective film should have efficient functioning at observation angles depending on the intended viewing distance. This is codified in specifications for pavement markings calling for function at 30 m distance to which an observation angle α=1.05° is assigned. Retroreflection angles α, β, and ω, for observation, entrance, and orientation, respectively, are defined in CIE 54.2, ASTM E808

In an embodiment, for a reflective device 100 to have highly efficient functioning the retroreflective strip 120 is prismatic and has 100% active aperture to the incoming, nearly horizontal light, when it is mounted with the specified retroreflective slopeback.

In an embodiment, in order for a retroreflective sheet or film to have efficient functioning in the retroreflective device it can be aberrated so as to reflect with observation angles such as α=1.05° over most of its surface, e.g., 50% to 100%, 60% to 95%, or 70% to 90%, but, aberrated differently or not at all so as to reflect with smaller observation angles, like α=0.2°, or 0.15 to 0.3°, 0.175 to 0.275°, or 0.19 to 0.225°, near its upper edge (e.g., within X % of the height of the sheet) as mounted on the front-upward angled surface 110 in the reflective device 100.

In an embodiment, the reflective devices could have a luminous intensity according to ASTM E1710 in dry conditions of at least 300,000 millicandela, such as, e.g., 325,000 to 600,000, or 400,000 to 550,000. In an embodiment, the reflective devices could have a luminous intensity according to ASTM 1710 in wet conditions of at least 250,000 millicandela, such as, e.g., 270,000 to 400,000, or 280,000 to 325,000. In an embodiment, the reflective devices have a luminous intensity according to ASTM 1710 in underwater conditions of at least 100,000 millicandela, such as, e.g., 125,000 to 250,000, or 150,000 to 225,000.

### EXAMPLES

### Examples 1-7

A reflective device corresponding to that shown in FIGS. 1 and 2 with a front-upward angled surface 110 of 120 degree angle measured from the horizontal plane 181 extending from the bottom 140 of the reflective device 100 (see FIG. 2, first angle 201) was tested with various different reflective sheetings. At ASTM E1710 conditions, examples with different reflective sheetings on a reflective device with 60 degree front-upward angle had luminosity values from a CEN pavement marking photometer as follows (these numbers are in candela):

TABLE 2

| | | Luminous |
|---|---|---|
| Example | Type | intensity |
| Example 1 | 3M Diamond Grade³ | 48.6 |
| Example 2 | 3M Diamond Grade | 27.1 |
| | VIP | |
| Example 3 | 3M High Intensity | 14.2 |
| Example 4 | Super Eng. Grade | 13.2 |
| Example 5 | Eng. Grade | 10.2 |
| Example 6 | AVERY DENNISON | 10.1 |
| | T7500 | |
| Example 7 | 3M Diamond Grade | 9.5 |
| | LDP | |

High Intensity, Super Eng. Grade and Eng. Grade are reflective sheeting products manufactured with glass beads as opposed to microprisms. Glassbead reflective sheeting comprises encapsulated glass beads. The others are microprismatic reflective sheeting. Generally, retroreflective sheeting will perform better than glass bead type coverings on the front-upward angled surface of the reflective device.

### Comparative Example 1

The glassbead reflective sheetings have essentially zero reflectivity to a CEN pavement marking photometer if laid flat on a roadway when measured at a typical 88.76° entrance angle.

### Example 8

Example 8 was conducted by a third party testing facility on reflective devices as shown in FIGS. 1 and 2, with a 120 degree angle first angle 201 (see FIG. 2). The Example 8 device had height, width, and length (mm) as follows: 3.1, 29.9, and 101.8 (respectively). The angle between the base and the lens was 120 degrees, the same as above for Examples 1-7 (see FIG. 2, first angle 201).

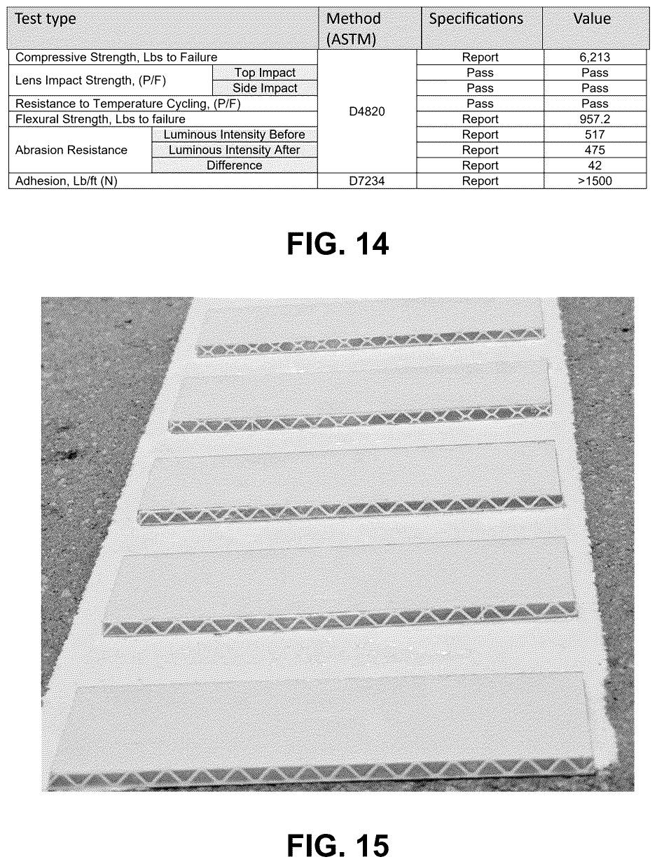

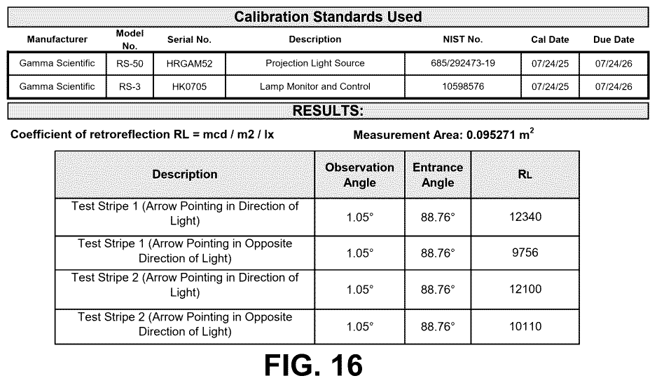

The reflective devices were placed in 2-part SWARCO traffic paint (3180 MFU-10 White) approximately 119 mm apart. FIG. 14 shows various physical properties that were tested along with the ASTM standard used.

Lens impact strength testing assessed the reflective face of a typical reflector laid flat. Due to the low profile of the product, accurate impact could not be fully made to the reflective face of the reflector. To thoroughly assess, both the top of the reflective device, and the side (the reflective face) were impacted. The impact dart is significantly larger than the face of the reflector, and thus the impact affected the reflective device differently. Both impacts caused minor indentation on the product. However, the reflective device was considered to pass this test.

The reflective device also passed the temperature cycling test of ASTM D4820. Flexural strength was also tested and reported on.

With respect to abrasion resistance: testing was conducted by painting a line with the above SWARCO polyurethane-based paint, letting it dry, and then setting the reflective devices on top. Initial readings were taken, and then the reflective devices were removed, stacked together and placed in the apparatus for sand abrasion. After abrasion they were placed back down on the paint line and re-tested for luminous intensity.

With respect to adhesion resistance, adhesion values were higher than the limitations of the instrument and substrate used for testing.

The lens impact strength and the abrasion resistance showed the surprising and superior durability of the reflective devices, largely due to the impact absorbing lip (or brow) design feature. Field testing of pavement marking devices that do not include a brow over two years indicated that the area that incurs the most damage due to tire impact is at the top of the face. By providing a tire impact-absorbing lip or brow at the top of the device, it was determined through this testing that the brow can significantly reduce damage to the upper area of the reflective film and significantly enhance the overall durability of the reflective device.

All testing above was conducted in replicates of 5.

### Examples 9-13

The reflective devices were tested for luminous intensity when wet and underwater according to ASTM E1709. The water level was just above the top of the reflective devices. While quanitative data from this method was deemed imprecise, it was clear that the underwater reflectivity performance was surprisingly effective and exceptional compared to conventional alternatives. Examples 14-18

The reflective devices were again tested for luminous intensity when wet and underwater according to ASTM E1709. This time, the reflectors were spaced out one in front of another in white, two-part, SWARCO traffic paint. FIG. 15 is a photo showing the lined up and spaced out reflective devices that were tested. While quantitative data from this method was deemed to be imprecise, it was clear that the underwater reflectivity performance was surprisingly effective and exceptional compared to conventional alternatives. Comparative Example 2

Conventional, flat reflective glass bead-based traffic lines have essentially no reflectivity under water.

### Examples 19-23

Samples as described above, in the format shown in FIG. 15, were measured at Gamma Scientific in accordance with test methods outlined in ASTM D4061. Two different samples were tested in two opposing directions. According to ASTM D4061 5.3, since this test method was a laboratory procedure, test specimens were be prepared so that they can be mounted on the specimen holder. Specimens measured by this laboratory method may also be used as transfer standards for the calibration of portable instrumentation.

All test equipment met the requirements of ASTM E809 (Standard Practice for Measuring Photometric Characteristics of Retroreflection), ASTM E1710 (Standard Test Method for Measurement of Retroreflective Pavement Marking Materials with CENPrescribed Geometry Using a Portable Retroreflectometer), and EN 1436, Annex B (Road marking materials—Road marking performance for road users). ASTM E809 Procedure A, the Ratio Method, was used to determine the retroreflection values of the examples. The temperature was 23° C. and relative humidity was 41%.

All calibrations were performed using internationally recognized standards calibrated by the National Institute of Standards and Technology (NIST). The NIST test equipment used was maintained at a level of accuracy that ensures complete conformance to ISO/IEC 17025 and ANSI/NCSL Z540-1-1994 requirements. What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially” as used herein means the specified materials or steps and those that do not materially affect the basic and novel characteristics of the material or method. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

1. A retroreflective pavement marking device comprising:
a top surface and a bottom;
a front-upward angled surface;
a reflective strip coupled to the front-upward angled surface; and
a lip that at least partially overhangs the front-upward angled surface and the reflective strip.

2. The retroreflective pavement marking device of claim 1, wherein the lip overhangs 50% to 100% of the front-upward angled surface.

3. The retroreflective pavement marking device of claim 1, wherein the reflective strip comprises a top layer and an inner retroreflective layer, in which retroreflective geometrical elements are embossed therein.

4. The retroreflective pavement marking device of claim 3, wherein the inner retroreflective layer comprises an acrylate.

5. The retroreflective pavement marking device of claim 3, wherein the top layer comprises a polyurethane.

6. The retroreflective pavement marking device of claim 1, wherein the front-upward angled surface is at a first angle with respect to a horizontal plane extending from the bottom of the retroreflective pavement marking device, wherein the first angle is 110° to 145°.

7. The retroreflective pavement marking device of claim 1, wherein the front-upward angled surface is at a first angle with respect to a horizontal plane extending from the bottom of the retroreflective pavement marking device, wherein the first angle is 120° to 135°.

8. The retroreflective pavement marking device of claim 1, wherein the bottom includes a raised portion with an undercut.

9. The retroreflective pavement marking device of claim 1, wherein the lip includes a bottom lip surface and a top lip surface and a second angle is formed between the bottom lip surface and the front-upward angled surface, wherein the second angle is in a range of 50° to 130° degrees.

10. The retroreflective pavement marking device of claim 1, wherein the reflective strip is coupled to the front-upward angled surface by laser welding.

11. A system for pavement marking on a road surface, the road surface having a center axis running along its longest dimension, the system comprising:
first and second reflective devices each having a long axis running through a center of their longest dimension;
the first and second reflective devices attached to a road surface, berm, or a groove in the road surface or berm;
the first reflective device being spaced away from the second reflective device further up or down the road surface, berm, or a groove in the road surface or berm;
at least the first reflective device being angled away from a 90 degree angle with the center axis of the road surface.

12. The system of claim 11, wherein the first reflective device is angled away from the 90 degree angle with the center axis of the road surface by 2 to 45 degrees.

13. The system of claim 11, wherein the first reflective device includes retroreflective geometrical elements that are configured to cause retroreflected light to be centered parallel to the center axis of the road surface at 30 meters from the reflective device, or 2 to 6 degrees further towards the center axis of the road surface than directly perpendicular to the center axis.

14. The system of claim 11, wherein the first reflective device has retroreflective geometrical elements that achieve two or more angles of reflectance.

15. The system of claim 11, wherein the first reflective device has a first angle of reflectance and the second reflective device has a second angle of reflectance.

16. A method of making a pavement marking, comprising:
manufacturing a pavement marking form comprising a front surface for a reflective strip;
positioning the reflective strip over the front surface; and
laser welding the reflective strip to the front surface.

17. The method of claim 16, wherein the manufacturing the pavement marking form comprises:
profile extruding a plastic or metal to form an extruded profile; and
cutting the extruded profile to form the pavement marking form.

18. The method of claim 16, wherein the front surface is a front-upward angled surface.

19. The method of claim 16, wherein the pavement marking comprises a lip overhanging the front surface.

20. The method of claim 16, wherein the reflective strip is a retroreflective strip.
